(19) United States
(12) Patent Application Publication
(10) Pub. No.: US 2015/0304250 A1
(43) Pub. Date: Oct. 22, 2015

(54) ONLINE SHOPPING IN EMAIL MESSAGES

(71) Applicant: Google Inc., Mountain View, CA (US)

(72) Inventors: Asaf Zomet, Jerusalem (IL); Michael Shynar, Kiryat Ono (IL)

(73) Assignee: Google Inc., Mountain View, CA (US)

(21) Appl. No.: 14/051,695

(22) Filed: Oct. 11, 2013

(51) Int. Cl. H04L 12/58; G06Q 30/02

(52) U.S. Cl. CPC H04L 51/046; G06Q 30/0277

(57) ABSTRACT

A method includes receiving, at an email service implemented by one or more server computers, an email message addressed to a user from a seller; and outputting, for display at a client computing device associated with the user, an email interface screen having a user operable interface element for ordering goods or services that are described in the email message. The method also includes receiving, at the email service, information indicating operation of the user operable interface element; and in response to receiving the information indicating operation of the user operable interface transmitting a purchase request relating to the goods or services.

### BACKGROUND

The disclosure herein relates generally to electronic mail (email) services that facilitate online shopping in email messages.

Email is commonly used to deliver targeted messages that promote goods and services. In some email marketing campaigns, an email message is encoded in a rich format, such as HTML, and includes a link by which the recipient can navigate to a web site where the recipient can place an order for goods or services that are offered for sale by the sponsor of the email marketing campaign. In a typical email marketing campaign, the user is typically required to navigate to a web site, initiate a purchase transaction using the web site, and then complete the purchase transaction at the web site, such as by logging into an existing user account at the web site, establishing a new user account associated with the web site, or by providing payment information and shipping information without establishing an account.

### SUMMARY

The disclosure relates to online shopping in email messages.

One aspect of the disclosed embodiments is a method that includes receiving, at an email service implemented by one or more server computers, an email message addressed to a user from a seller. The method also includes outputting, for display at a client computing device associated with the user, an email interface screen having a user operable interface element for ordering goods or services that are described in the email message. The method also includes receiving, at the email service, information indicating operation of the user operable interface element, and in response to receiving the information indicating operation of the user operable interface element transmitting a purchase request relating to the goods or services.

Another aspect of the disclosed embodiments is a method that includes receiving, at an email service implemented by one or more server computers, an email message addressed to a user from a seller. The method also includes identifying, by the email service, at least one instruction in the email message for invoking a purchase facilitation function of the email service with respect to goods or services that are described in the email message. The method also includes outputting, for display at a client computing device associated with the user, an email interface screen including content from the email message and a user operable interface element for executing the purchase facilitation function of the email service. The method also includes receiving, at the email service, information indicating operation of the user operable interface element for executing the purchase facilitation function, and in response to receiving the information indicating operation of the user operable interface element for executing the purchase facilitation function, executing, at the email service, the purchase facilitation function.

Another aspect of the disclosed embodiments is a method that includes receiving, at an email service implemented by one or more server computers, an email message addressed to a user from a seller, and outputting, for display at a client computing device associated with the user, an email interface screen having a user operable interface element for ordering goods or services that are described in the email message. The method also includes receiving, at the email service, information indicating operation of the user operable interface element. In response to receiving the information indicating operation of the user operable interface element, the method includes transmitting, from the email service to a payment service, a payment request. In response to receiving the payment request, the method includes transferring, by the payment service, a payment from an account associated with the user to an account associated with the seller.

### BRIEF DESCRIPTION OF THE DRAWINGS

The description herein makes reference to the accompanying drawings wherein like reference numerals refer to like parts throughout the several views, and wherein:

FIG. 1 is a block diagram showing an example of a system for online shopping in email messages;

FIG. 2 is a block diagram showing an example of a host computer;

FIG. 3 is an illustration showing an electronic mail interface screen according to a first example;

FIG. 4 is an illustration showing an electronic mail interface screen according to a second example;

FIG. 5 is an illustration showing an electronic mail interface screen according to a third example;

FIG. 6 is an illustration showing an electronic mail interface screen according to a fourth example;

FIG. 7A is a block diagram showing transmission of a purchase request according to a first example;

FIG. 7B is a block diagram showing transmission of a purchase request according to a second example;

FIG. 7C is a block diagram showing transmission of a purchase request according to a third example; and

FIG. 8 is a flow chart showing an example of a process for online shopping in email messages.

### DETAILED DESCRIPTION

Methods and systems for online shopping in email messages are disclosed herein. In the methods disclosed herein, an email service allows users to complete a purchase transaction within the interface provided by the email service. This functionality can be triggered using information that is contained with an email message. As an example, an email message can be output for display in an email interface screen, where the email message offers goods or services for sale, and the email interface screen includes a user operable interface element for accepting the offer to sell goods or services. When the interface element is operated by the user, the email service transmits a purchase request to a system that is associated with a seller of the goods or services that are described in the email message. In some implementations, the email service causes payment for the goods or services to be transferred from an account associated with the user to an account associated with the seller. Using the methods and systems disclosed herein, purchases can be completed within the email interface screen, thus reducing the number of actions that must be taken by a user to purchase the goods or services. Also, some implementations of the methods and systems described herein can be utilized by merchants that lack a web site having online shopping functionality.

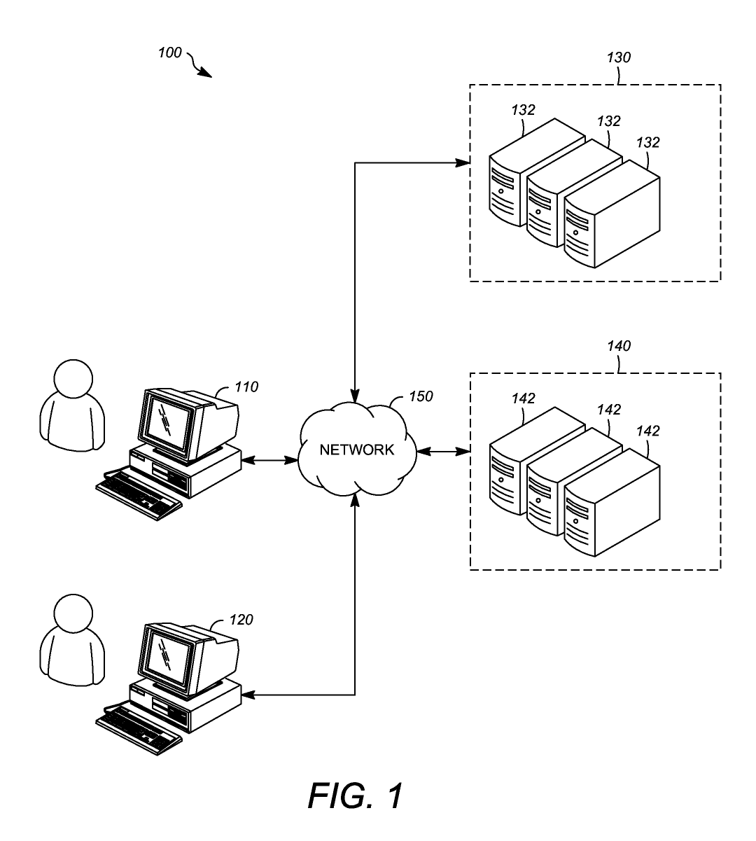

FIG. 1 shows an example of an environment 100 in which a system for online shopping in email messages can be implemented. The environment 100 can include a user system 110, a merchant system 120, an email service 130, and a payment service 140. The user system 110 and the merchant system 120 are each representative of a large number (e.g. millions) of user systems and merchant systems that can be included in the environment 100. The user system 110 and the merchant system 120 can each be any manner of computer or computing device, such as a desktop computer, a laptop computer, a tablet computer, or a smart-phone (a computationally-enabled mobile telephone). The email service 130 can be implemented using one or more server computers 132. The payment service 140 can be implemented using one or more server computers 142. As used herein, the term “server computer” means any computing device that can receive a request from another computing device and transmit a response to the request. The user system 110, the merchant systems 120, the email service 130, and the payment service 140 can each be implemented as a single system, multiple systems, distributed systems, or in any other form.

The systems, services, servers, and other computing devices described herein are in communication via a network 150. The network 150 can be one or more communications networks of any suitable type in any combination, including wireless networks, wired networks, local area networks, wide area networks, cellular data networks, and the internet.

The email service 130 provides an email service to the user system 110. The description herein will be made with respect to a web-based email service in that provides a web-browser-based interface for viewing mailboxes and email messages. It should be understood, however, that the email service can be provided in many other forms, such as in the form of an “app” that is executed by a tablet computer or a smart-phone, or in the form of desktop software that is executed by a personal computer.

The payment service 140 facilitates payments between two parties. In some of the examples herein, the payment service 140 can facilitate payment from a user that is associated with the user system 110 to a merchant that is associated with the merchant system 120. The payment service 140 can be separate from the email service 130, or can be implemented as a part of the email service 130.

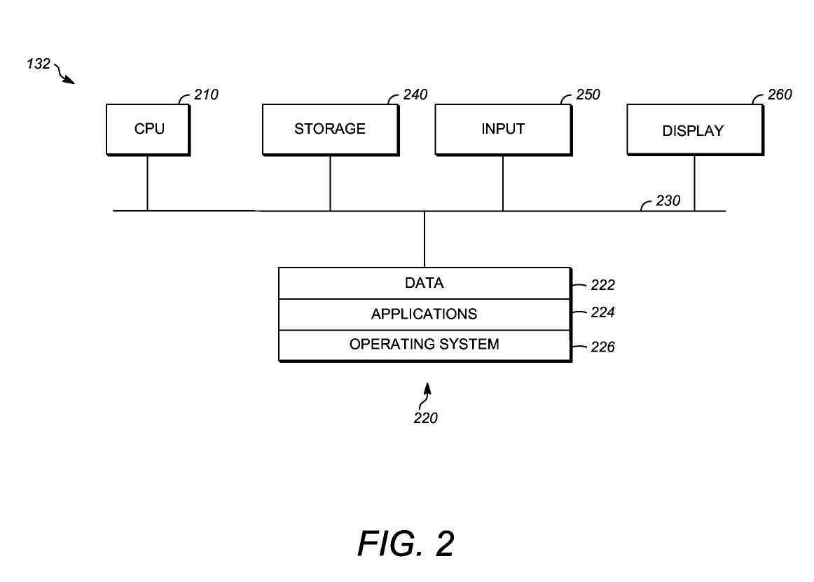

FIG. 2 is a block diagram of an example of a hardware configuration for the one or more server computers 132 of the email service 130. The same hardware configuration or a similar hardware configuration can be used to implement the user system 110, the merchant systems 120 and the one or more server computers of the payment service 140. Each server computer 132 can include a CPU 210. The CPU 210 can be conventional central processing units. Alternatively, the CPU 210 can be any other type of device, or multiple devices, capable of manipulating or processing information now-existing or hereafter developed. Although the disclosed examples can be practiced with a single processor as shown, e.g. CPU 210, advantages in speed and efficiency can be achieved using more than one processor.

Each server computer 132 can include memory 220, such as a random access memory device (RAM). Any other suitable type of storage device can be used as the memory 220. The memory 220 can include code and data 222 that can be accessed by the CPU 210 using a bus 230. The memory 220 can further include one or more application programs 224 and an operating system 226. The application programs 224 can include software components in the form of computer executable program instructions that cause the CPU 210 to perform the operations and methods described herein.

A storage device 240 can be optionally provided in the form of any suitable computer readable medium, such as a hard disc drive, a memory device, a flash drive or an optical drive. One or more input devices 250, such as a keyboard, a mouse, or a gesture sensitive input device, receive user inputs and can output signals or data indicative of the user inputs to the CPU 210. One or more output devices can be provided, such as a display device 260. The display device 260, such as liquid crystal display (LCD) or a cathode-ray tube (CRT), allows output to be presented to a user, for example, in response to receiving a video signal.

Although FIG. 2 depicts the CPU 210 and the memory 220 of each server computer 132 as being integrated into a single unit, other configurations can be utilized. The operations of the CPU 210 can be distributed across multiple machines (each machine having one or more of processors) which can be coupled directly or across a local area or other network. The memory 220 can be distributed across multiple machines such as network-based memory or memory in multiple machines. Although depicted here as a single bus, the bus 230 of each of each server computer 132 can be composed of multiple buses. Further, the storage device 240 can be directly coupled to the other components of the respective one of the server computers 132 or can be accessed via a network and can comprise a single integrated unit such as a memory card or multiple units such as multiple memory cards. The one or more server computers can thus be implemented in a wide variety of configurations.

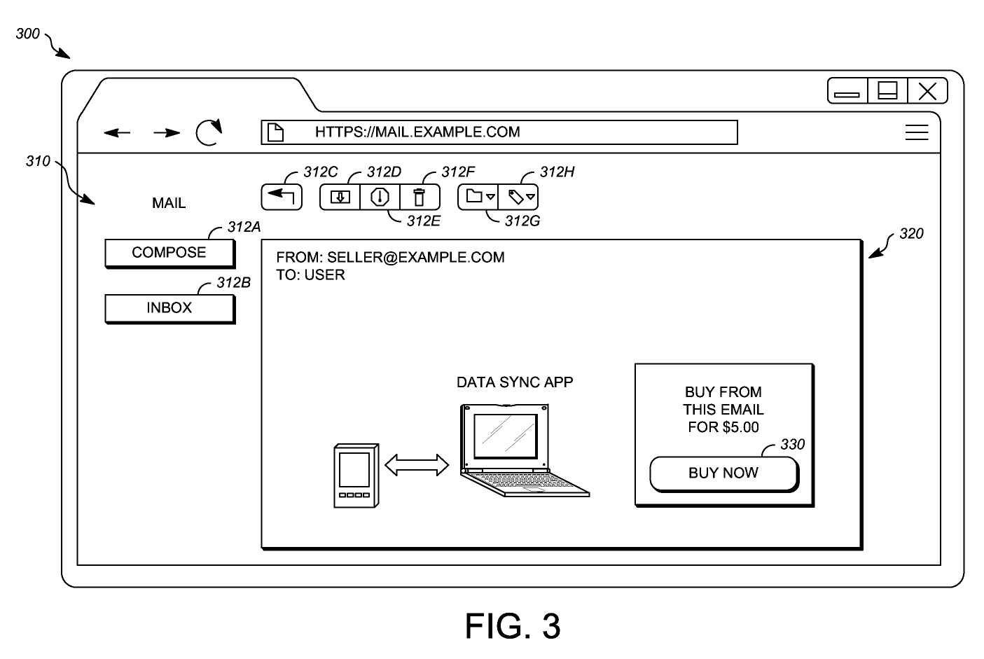

FIG. 3 shows an email interface screen 300 according to a first example. The email interface screen 300 is displayed in the context of a web browser and can be, for example, a webpage encoded in a markup language such as HTML that is transmitted from the email service 130 to the user system 110 and output for display at the user system 110.

The email interface screen 300 includes a control area 310 and a message display area 320. The control area 310 can include interface elements for causing performance of functions provided by the email service 130. As one example, the interface elements contained within the control area 310 can be buttons that are activated by a click, a tap, or any other type of interface action. Other types of interface elements can be utilized within the control area 310 in addition to or as an alternative to buttons. As examples, the control area 310 can include a compose button 312A for displaying an interface in which a new email message can be composed, an inbox button 312B for displaying the user's inbox, a reply button 312C for allowing the user to reply to a currently displayed email message, an archive button 312D for sending the currently displayed email message to a message archive, a spam button 312E for marking the currently displayed email message as spam message, a delete button 312F for deleting the currently displayed email message, a folder button 312G for moving the currently displayed email message into a folder, and a label button 312H for applying one or more labels to the currently displayed email message for use in organizing or searching for email messages. Additional buttons or other interface elements can be provided in the control area 310 for invoking different or additional functions of the email service 130.

The message display area 320 of the email interface screen 300 can display a message that is received at the email service 130. In typical examples, the message is addressed to the user of the user system 110 and is sent by a third-party sender.

The email message that is displayed within the message display area 320 includes a description of goods or services that are being offered for sale by a seller, such as the users associated with the merchant system 120. In this example, the email message that is displayed within the message display area 320 includes an offer for sale of a “data sync app” and invites the user to “buy from this email for five dollars.” The email interface screen 300 includes a user operable interface element 330, where activation of the user operable interface element 330 allows the user to order the goods or services that are described in the email message that is displayed within the message display area 320. In the email interface screen 300, the user operable interface element 330 is displayed within the message display area 320 as part of the email message.

The user operable interface element 330 is displayed in response to at least one instruction within the email message. The instruction can be in any format, examples of which include an HTML element, such as a hyperlink, a form element, a script instruction, a comment, or information in the header of the email message. In some implementations, as will be discussed further herein, the email service 130 can identify the presence of the at least one instruction within the email message and modify the contents of the email message as it is output for display within the message display area 320 as part of the purchase facilitation function.

When the user operable interface element 330 is operated by the user, information is transmitted from the user system 110 to the email service 130 indicating that the user wishes to execute the purchase facilitation function of the email service 130. In response to receiving this information, the email service 130 can execute the purchase facilitation function. As one example, the purchase facilitation function can include transmitting, from the email service 130 to a system associated with the seller of the goods or services described in the email message, a purchase request relating to the email message. Subsequent to operation of the user operable interface element 330, in some implementations, any additional information required from the user and/or any confirmation of the purchase can be output for display within the email interface screen 300. Thus, the user is able to purchase the goods or services that are described in the email message without navigating away from the email interface screen to, for example, an external website associated with the seller, and operation of the user operable interface element 330 does not cause, in such implementations, navigation away from the email interface screen. Thus, in some implementations, a purchase can be completed by the user directly from the email interface screen by a single action (e.g. clicking a button).

The purchase request can be any type of information or data suitable to inform the seller, such as the users associated with the merchant system 120, that the user system 110 has made a purchase request using the user operable interface, 330. For Example, the purchase facilitation function can include sending, by the email service 130 and to the merchant system 120, an email message indicating that a purchase has been requested by the user of the user system 110, including identification of the user system 110 and any other information required by the merchant system 120. The purchase request can include a postal mail address that is associated with the user and/or payment information that is associated with the user. The payment information can be, for example, information identifying an account that is held by the user with a third party payment processor, as well as authorization by the user to allow the merchant system 120 request payment from the third party payment processor.

As another example, the purchase facilitation function can include transferring payment from an account associated with the user to an account associated with the seller such as the operator of the merchant system 120. In this example, the email service 130 can transmit a message to the payment service 140 that includes information that is sufficient for the payment service 140 to identify the account associated with the user and the account associated with the seller, such as an identity of the user of the user system 110 and the identity of the operator of the merchant system 120. In response to receiving this information from the email service 130, the payment service 140 can transfer the payment from the account associated to the user to the account associated with the seller and, optionally, send messages, such as email messages, to the user of the user system 110 and the operator of the merchant system 120 that alert each party as to completion of the transfer of the payment.

In another example, the payment service 140 is not utilized, and instead, payment is handled by presenting a dialog to the user by which the user can log into an account that the user previously established with the seller or by which the user can supply payment information to the seller. Such a dialog can be presented within the email interface screen 300, and thus, payment can be made without navigating away from the email interface screen 300.

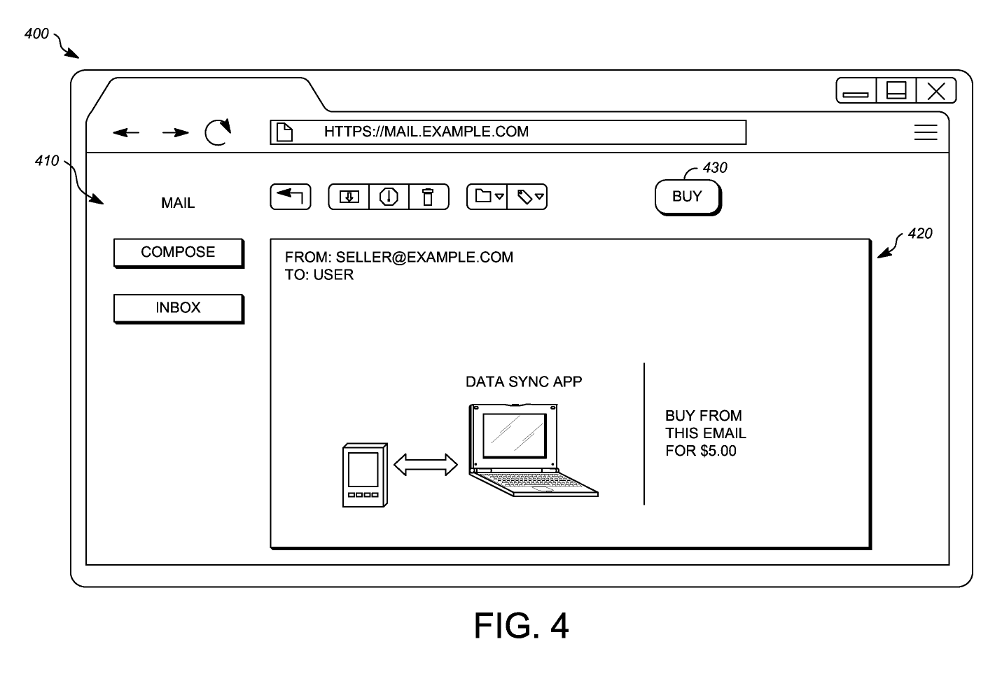

FIG. 4 shows an email interface screen 400 according to a second example. The email interface screen 400 is similar to the email interface screen 300, except as otherwise noted herein, and includes a control area 410 and a message display area 420. Within the message display area 420, an email message is displayed that includes a description of goods or services that are being offered for sale by the seller. The email message includes at least one instruction that causes the email service 130 to output, for display along with the email message, a user operable interface element 430 for accepting the offer to sell goods or services and causing the email service 130 to execute a purchase facilitation function, such as transmitting a purchase request from the email service 130 to the merchant system 120. In the email interface screen 300, the user operable interface element 430 is displayed within the control area 410, and thus is outside of the message display area 420 and is not displayed as part of the message therein. Placing the user operable interface element 430 within the control area 410 can, for example, communicate to the user the fact that the purchase described within the message display area 420 can be performed within the email interface screen 400 without navigating to an external website. As another example, placing the user operable interface element in the control area 410 can indicate to the user that some portion of the purchase transaction is being facilitated by the email service 130. The operation of the user operable interface element 430 is as described with respect to the user operable interface element 330 of the email interface screen 300.

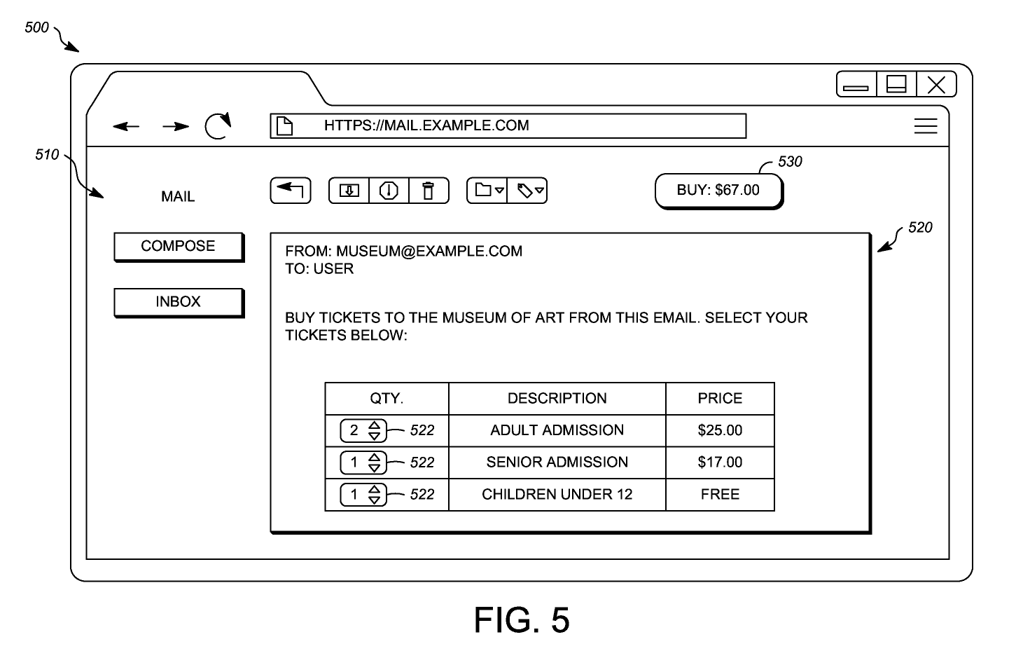

FIG. 5 shows an email interface screen 500. The email interface screen 500 is similar to the email interface screen 300 of FIG. 3, except as noted herein. The email interface screen 500 includes a control area 510 and a message display area 520. The control area 510 is similar to the control area 310 of the email interface screen 300.

The message display area 520 of the email interface screen 500 displays an email message having at least one form element for modifying information related to the goods or services that are described within the email message. In this example, the email message that is displayed within the message display area 520 incorporates form elements in the form of controls 522 that allow the user to specify a quantity of one or more items that are offered for sale within the email message. The controls 522 can, in other implementations, be used to provide other information relating to the goods or services that are described in the email message. For example, the controls 522 could be used to provide information such as a quantity, a size, or a color of the goods or services that are described in the email message that the user wishes to purchase. Examples of controls include a text box, a radio button, a checkbox, a drop down list, a list box, a combo box, a quantity selector (e.g. a spinner), or any other suitable type of control that can receive input from a user.

The email interface screen 500 includes a user operable interface element 530 in the form of a button that is displayed within the control area 510 in response to instructions that are included within the email message. In this example, the user operable interface element 530 includes a text legend including text “buy” for indicating to the user that operation of the user operable interface element 530 will cause the email service 130 to transmit a purchase request to the seller. The user operable interface element 530 also includes an indication as to the total price of the purchase, which in this case, is a numerical indication as to the purchase price that is included within the user operable interface element 530 can be calculated based on the quantity specified the by the controls 522 in combination with a price for each of the items to which the controls 522 relate, based on information that is contained within the email message that is displayed within the message display area 520.

Upon operation of the user operable interface element 530 by the user, information is sent to the email service 130 that indicates that the user operable interface element 530 has been operated by the user, along with information indicating the state of each of the controls 522, thereby providing additional information to the email service 130, namely, the quantities for each of the items that the user wishes to purchase. This information is included in the purchase request that is transmitted to a system associated with the seller, such as the merchant system 120, by the email service 130.

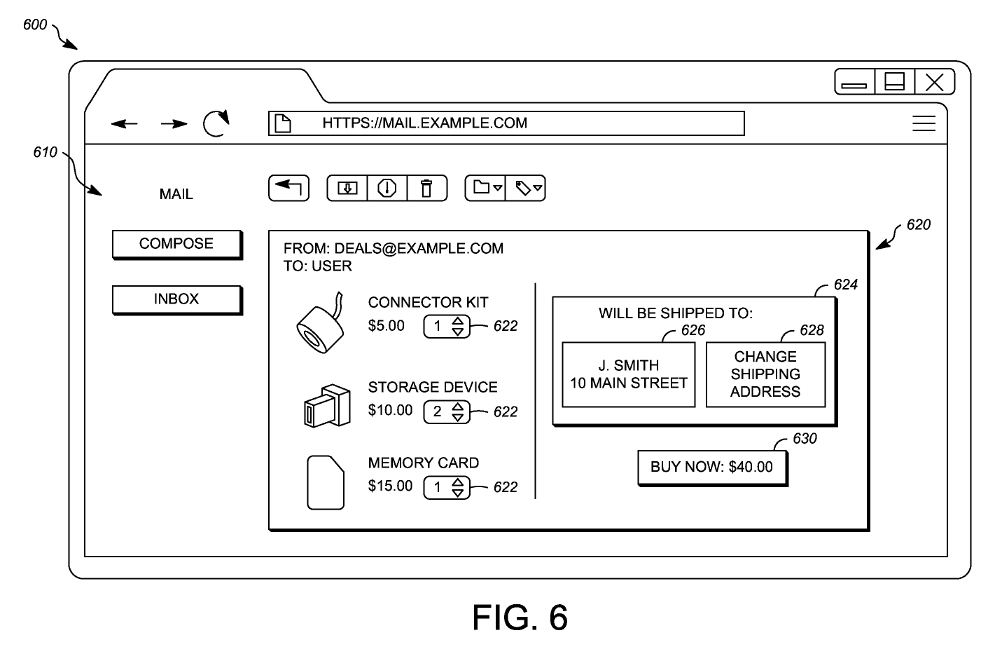

FIG. 6 shows an email interface screen 600 according to a fourth example. The email interface screen 600 is similar to the email interface screen 300 of FIG. 3 except as otherwise noted herein. The email interface screen 600 includes a control area 610 and a message display area 620. Within the message display area 620, the email message includes an offer for sale of several products, as well as one or more form elements, which in this case are controls 622 for specifying the quantity of each item that the user wishes to purchase, and operate as described with respect to the controls 522 of FIG. 5.

The message display area 620 includes a dialog 624 that allows the user to confirm or specify information related to the purchase. As one example, the information related to the purchase includes a postal mail address to which the products will be shipped. As another example, the information related to the purchase includes a selection of a shipping method.

In the illustrated example, the dialog 624 includes a text display 626 of a current postal mail address for the user. The current postal mail address for the user, as displayed within the text display 626, can be a default postal mail address. As one example, the default postal mail address can be determined based on previously-stored information that is associated with the user, such as information stored at the email service 130 in association with the user account for the user. As another example, the default postal mail address can be determined based on information contained in the email message. The dialog 624 can also include a button 628 that allows the user to change the current postal mail address to an alternative postal mail address to which the products will be shipped, for example, after editing the information within the text display 626, in an implementation where the text display 626 is an editable field.

The email interface screen 600 also includes a user operable interface element 630 in the form of a button that is displayed within the message display area 620. As in the email interface screen 500 of FIG. 5, the total amount of the purchase is displayed within the user operable interface element 630 to allow the user to understand the total price for the transaction. Operation of the user operable interface element 630 serves both to transmit information to the email service 130 for causing the email service 130 to transmit a purchase request as well as confirming the postal mail address displayed within the dialog 624.

In one implementation, the dialog 624 is displayed as part of the email message prior to operation of the user operable interface element 630. In another implementation, the dialog 624 is displayed within the email interface screen in response to operation of the user operable interface element 630.

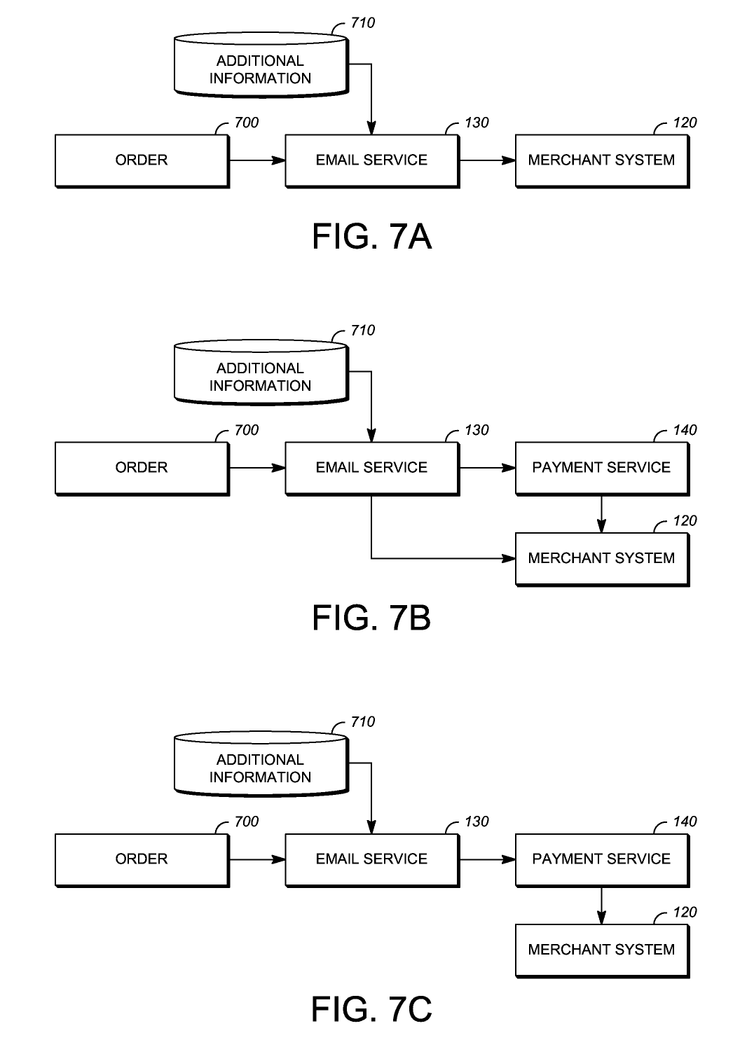

FIG. 7A is a block diagram showing transmission of a purchase request according to a first example. Information regarding an order 700 is transmitted from the user system 110 to the email service 130 in response to, for example, operation of the user operable interface element 330 FIG. 3. In response to receiving the information regarding the order 700, the email service 130 generates a purchase request regarding the goods or services that are described in the email message, and transmitted to the purchase request to the merchant system 120. The purchase request can include information that identifies the email message, the recipient of the email message, the goods or services described in the email message, information supplied by the user of the user system 110 regarding the goods or services, and/or information regarding the user of the user system 110, such as an address for the user, payment information for the user, identification of a payment account associated with the user, or any other information associated with the user. Some or all of the information transmitted from the email service 130 to the merchant system 120 as part of the purchase request can be based on additional information 710 that is stored at the email service 130. For example, the additional information 710 can be information regarding the user that is stored in association with a user account for the user at the email service 130. The additional information 710 can be incorporated in the purchase request by the email service 130 in response to receiving the order 700 from user system 110.

FIG. 7B is a flow chart showing the generation of a purchase request according to a second example. In this example, in addition to transmitting the purchase request to the merchant system 120 as described with respect to FIG. 7A, the email service 130 simultaneously transmits a payment request to the payment service 140. The payment request can identify an account associated with the user of the user system 110, and an identity of the seller of the goods and services described in the email, such as information describing an account associated with the seller, and amount of funds to be transferred from the user to the seller as payment, information describing the transaction and/or any other information required or desired for completion of a payment transaction by the payment service 140. In response to receiving the payment request, from the email service 130, the payment service 140 can transmit information to the merchant system 120 regarding the payment request. For example, the payment service 140 can transmit a message to the merchant system 120 that confirms that a payment was transferred from the account associated with the user to the account associated with the seller.

FIG. 7C is a block diagram showing transmission of a purchase request according to a third example. In this example, the payment request and the purchase request are both simultaneously transferred from the email service 130 to the payment service 140. The payment service 140 operates as described with respect to FIG. 7B. In addition, the payment service 140 relays the purchase request to the merchant system 120 along with the information regarding the payment transaction, as previously described.

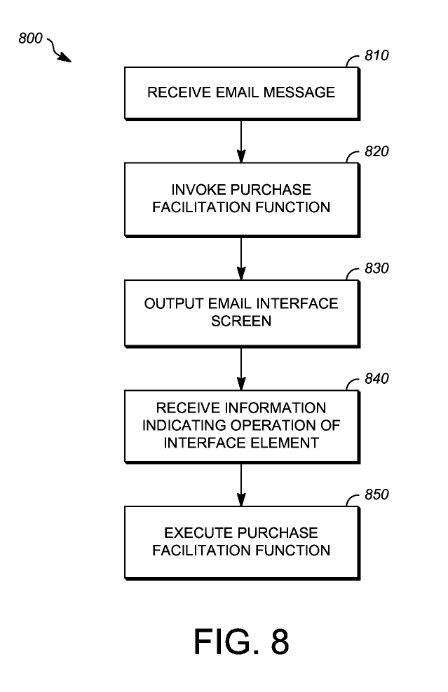

FIG. 8 is a flow chart showing a process 800 for online shopping in email messages.

The operations described in connection with the process 800 can be performed at one or more computers, such as at the one or more server computers 132 of the email service 130. When an operation is performed by one or more computers, it is completed when it is performed by one computer. The operations described in connection with the process 800 can be embodied as a non-transitory computer readable storage medium including program instructions executable by one or more processors that, when executed, cause the one or more processors to perform the operations. For example, the operations described in connection with the process 800 could be stored at the memory 220 of a respective one of the server computers 132 and be executable by the CPU 210 thereof.

At operation 810, an email message is received. The email message is received at a computing system when it is available at the computing system in any way, and by any means. As one example, an email message can be received at a computing system by transmission of the email message over a network. As another example, an email message can be received at a computing system by accessing the email from a database. Other examples are possible. Receiving the email message can be performed by the email service 130, for example, by receiving the email message via the network 150 by a transmission using the SMTP protocol, where the email is addressed to the user and is from the seller, which can be persons or entities associated with the merchant system 120.

At operation 820, a purchase facilitation function is invoked. The purchase facilitation function is invoked when it is made available for use in connection with the email message. As one example, the purchase facilitation function can be invoked in response to information included within the email. This information can be, for example, information in the header, or information encoded within the body of the message itself, such as script or markup language indicating that the purchase facilitation function should be utilized.

At operation 830, the email interface screen is output. Output means that data has been generated that, when interpreted, can cause the email interface screen to be displayed by a computing system. As one example, the email interface screen is output for display at the user system 110, which may be referred to herein as a client computing device, when the email service 130 generates information for causing the email interface screen to be displayed when that information is transmitted to, and interpreted at the user system 110. The email interface screen can include a user operable interface element for ordering goods and services that are described in the email message, as previously discussed.

At operation 840, information is received that indicates that the user operable interface element of the email interface screen has been operated by the user. This information can be received in any form and by any suitable means, such as by transmission of the information from the user system 110 to the email service 130 via the network 150. In one example, after the email interface screen is output for display at the user system 110, the user performs an interface action with respect to the user operable interface element, such as a click or tap, and information indicating operation of the user operable interface element is transmitted to the email service 130 in response to this interface action.

At operation 850, in response to receiving the information indicating operation of the user operable element, the purchase facilitation function is executed at the email service 130. With respect to executing the purchase facilitation function, the term execute means that the email service 130 has performed the operations associated with the purchase facilitation function or has caused the operations associated with the purchase facilitation function to be performed by one or more computing devices such as, for example, the email service 130 in combination with the payment service 140. As an example, executing the purchase facilitation function can include transmitting, from the email service to a system associated with the seller, a purchase request relating to the goods and services that are described in the email message. The system associated with the seller can be any system that performs any action on behalf of the seller, whether or not that system is directly controlled by the seller.

The purchase facilitation function, as executed at operation 850, is not limited to transmission of the purchase request from the email service 130 to the merchant system 120. As another example, the purchase facilitation function can include accessing previously-stored information that is associated with the user and transmitting the previously-stored information associated with the user to the system that is associated with the seller. The previously-stored information can be stored at the emails service, as explained with respect to the additional information 710 of FIGS. 7A-7C. The previously-stored information can be, or include, for example, an identity of the user, information identifying an account associated with user, a postal mail address for the user, payment information for the user, shipping preferences for the user, or any other type of information that may be useful to the purchase transaction. As a further example, the purchase facilitation function can include outputting, for display at the user system 110 as part of the email interface screen, a confirmation dialog for requesting, from the user, additional information regarding the purchase request. This can be, for example, information such as that described in connection with the dialog 624 of FIG. 6. When the additional information is received from the user system 110, that information can be incorporated into or transmitted with the purchase request to the merchant system 120.

The foregoing description describes only some exemplary implementations of the described techniques. Other implementations are available. For example, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

The implementations of the computer devices (e.g., clients and servers) described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of each of the clients and each of the servers described herein do not necessarily have to be implemented in the same manner.

Operations that are described as being performed by a single processor, computer, or device can be distributed across a number of different processors, computers or devices. Similarly, operations that are described as being performed by different processors, computers, or devices can, in some cases, be performed by a single processor, computer or device.

Although features may be described above or claimed as acting in certain combinations, one or more features of a combination can in some cases be excised from the combination, and the combination may be directed to a sub-combination or variation of a sub-combination.

The systems described herein, such as client computers and server computers, can be implemented using general purpose computers/processors with a computer program that, when executed, carries out any of the respective methods, algorithms and/or instructions described herein. In addition or alternatively, for example, special purpose computers/processors can be utilized which can contain specialized hardware for carrying out any of the methods, algorithms, or instructions described herein.

Some portions of above description include disclosure presented in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality. It should be noted that the process steps and instructions of implementations of this disclosure could be embodied in software, firmware or hardware, and when embodied in software, could be downloaded to reside on and be operated from different platforms used by real time network operating systems.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

At least one implementation of this disclosure relates to an apparatus for performing the operations herein. This apparatus may be specially constructed for the required purposes, or it may comprise a general-purpose computer selectively activated or reconfigured by a computer program stored on a computer readable storage medium that can be accessed by the computer.

All or a portion of the embodiments of the disclosure can take the form of a computer program product accessible from, for example, a non-transitory computer-usable or computer-readable medium. The computer program, when executed, can carry out any of the respective techniques, algorithms and/or instructions described herein. A non-transitory computer-usable or computer-readable medium can be any device that can, for example, tangibly contain, store, communicate, or transport the program for use by or in connection with any processor. The non-transitory medium can be, for example, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for tangibly containing, storing, communicating, or transporting electronic instructions.

It is to be understood that the disclosure is not to be limited to the disclosed embodiments but, on the contrary, is intended to cover various modifications and equivalent arrangements included within the spirit and scope of the appended claims.

What is claimed is:

1. A method comprising:
receiving, at an email service implemented by one or more server computers, an email message addressed to a user from a seller;
outputting, for display at a client computing device associated with the user, an email interface screen having a user operable interface element for ordering goods or services that are described in the email message;
receiving, at the email service, information indicating operation of the user operable interface element; and
in response to receiving the information indicating operation of the user operable interface element transmitting a purchase request relating to the goods or services.

2. The method of claim 1, further comprising:
in response to receiving the information indicating operation of the user operable interface element transferring a payment from an account associated with the user to an account associated with the seller.

3. The method of claim 1, further comprising:
in response to receiving the information indicating operation of the user operable interface element:
accessing, at the email service, previously-stored information associated with the user, and
transmitting the previously-stored information associated with the user to a system associated with the seller.

4. The method of claim 3, wherein the previously-stored information associated with the user includes a postal mail address for the user.

5. The method of claim 3, wherein the previously-stored information associated with the user includes payment information the user.

6. The method of claim 1, further comprising:
in response to receiving the information indicating operation of the user operable interface element:
outputting, for display at a client computing device associated with the user and as part of the email interface screen, a confirmation dialog for requesting, from the user, additional information regarding the purchase request.

7. The method of claim 6, wherein the additional information includes a postal mail address for the user.

8. The method of claim 6, further comprising:
determining, at the email service, a default postal mail address for the user based on previously-stored information associated with the user, wherein the default postal mail address for the user is displayed at the confirmation dialog and the additional information includes at least one of a confirmation of the default postal mail address or an alternative postal mail address.

9. The method of claim 6, further comprising:
determining, at the email service, a default postal mail address for the user based on the email message, wherein the default postal mail address for the user is displayed at the confirmation dialog and the additional information includes at least one of a confirmation of the default postal mail address or an alternative postal mail address.

10. The method of claim 1, wherein operation of the user operable interface element does not cause, at the client computing device, navigation away from the email interface screen.

11. The method of claim 1, wherein the email interface screen includes at least one form element for modifying information related to the goods or services, and the information related to the goods or services is transmitted to the email service in response to operation of the user operable interface element.

12. The method of claim 11, wherein the information related to the goods or services includes at least one of a quantity, a size, or a color.

13. The method of claim 1, wherein the email interface screen has a control area and a message display area, wherein the user operable interface element is displayed in the control area in response to at least one instruction in the email message.

14. The method of claim 1, wherein the email interface screen has a control area and a message display area, wherein the user operable interface element is displayed in the message display area.

15. A method comprising:
receiving, at an email service implemented by one or more server computers, an email message addressed to a user from a seller;
identifying, by the email service, at least one instruction in the email message for invoking a purchase facilitation function of the email service with respect to goods or services that are described in the email message;
outputting, for display at a client computing device associated with the user, an email interface screen including content from the email message and a user operable interface element for executing the purchase facilitation function of the email service;
receiving, at the email service, information indicating operation of the user operable interface element for executing the purchase facilitation function; and
in response to receiving the information indicating operation of the user operable interface element for executing the purchase facilitation function, executing, at the email service, the purchase facilitation function.

16. The method of claim 15, wherein the purchase facilitation function includes transmitting, from the email service to a system associated with the seller, a purchase request relating to the email message.

17. The method of claim 15, wherein the purchase facilitation function includes transferring a payment from an account associated with the user to an account associated with the seller.

18. The method of claim 15, wherein the purchase facilitation function includes outputting, for display at a client computing device associated with the user and as part of the email interface screen, a confirmation dialog for requesting, from the user, additional information.

19. The method of claim 15, wherein the email service executes the purchase facilitation function without causing, at the client computing device, navigation away from the email interface screen.

20. A method comprising:
receiving, at an email service implemented by one or more server computers, an email message addressed to a user from a seller;
outputting, for display at a client computing device associated with the user, an email interface screen having a user operable interface element for ordering goods or services that are described in the email message;
receiving, at the email service, information indicating operation of the user operable interface element;
in response to receiving the information indicating operation of the user operable interface element transmitting, from the email service to a payment service, a payment request; and
in response to receiving the payment request, transferring, by the payment service, a payment from an account associated with the user to an account associated with the seller.
